(19) United States
(12) Patent Application Publication
(10) Pub. No.: US 2011/0098973 A1
(43) Pub. Date: Apr. 28, 2011

(54) Automatic Baselining Of Metrics For Application Performance Management

(75) Inventor: David Isaiah Seidman, Durham, NC (US)

(73) Assignee: COMPUTER ASSOCIATES THINK, INC., Islandia, NY (US)

(21) Appl. No.: 12/605,087

(22) Filed: Oct. 23, 2009

(51) Int. Cl. G06F 17/18; G06F 15/00

(52) U.S. Cl. 702/179; 702/186

(57) ABSTRACT

An application monitoring system monitors one or more applications to generate and report application performance data for transactions. Actual performance data for one or more metrics is compared with a baseline metric value(s) to detect anomalous transactions or components thereof. Automatic baselining for a selected metric is provided using variability based on a distribution range and arithmetic mean of actual performance data to determine an appropriate sensitivity for boundaries between comparison levels. A user-defined sensitivity parameter allows adjustment of baselines to increase or decrease comparison sensitivity for a selected metric. The system identifies anomalies in transactions, components of transaction based on a comparison of actual performance data with the automatically determined baseline for a corresponding metric. The system reports performance data and other transactional data for identified anomalies.

### BACKGROUND

Maintaining and improving application performance is an integral part of success for many of today's institutions. Businesses and other entities progressively rely on increased numbers of software applications for day to day operations. Consider a business having a presence on the World Wide Web. Typically, such a business will provide one or more web sites that run one or more web-based applications. A disadvantage of conducting business via the Internet in this manner is the reliance on software and hardware infrastructures for handling business transactions. If a web site goes down, becomes unresponsive or otherwise fails to properly serve customers, the business may lose potential sales and/or customers. Intranets and Extranets pose similar concerns for these businesses. Thus, there exists a need to monitor web-based, and other applications, to ensure they are performing properly or according to expectation.

Developers seek to debug software when an application or transaction is performing poorly to determine what part of the code is causing the performance problem. Even if a developer successfully determines which method, function, routine, process, etc. is executing when an issue occurs, it is often difficult to determine whether the problem lies with the identified method, etc., or whether the problem lies with another method, function, routine, process, etc. that is called by the identified method. Furthermore, it is often not apparent what is a typical or normal execution time for a portion of an application or transaction. Production applications can demonstrate a wide variety of what may be termed normal behavior depending on the nature of the application and its business requirements. In many enterprise systems, it may take weeks or months for a person monitoring an application to determine the normal range of performance metrics. Standard statistical techniques, such as those using standard deviation or interquatile ranges, may be used to determine whether a current metric value is normal compared to a previously measured value. In the context of many systems, such as web-application monitoring for example, standard statistical techniques may be insufficient to distinguish between statistical anomalies that do not significantly affect end-user experience from those that do. Thus, even with information regarding the time associated with a piece of code, the developer may not be able to determine whether the execution time is indicative of a performance problem or not.

### SUMMARY OF THE INVENTION

An application monitoring system monitors one or more applications to generate and report application performance data for transactions. Actual performance data for one or more metrics is compared with corresponding baseline metric value(s) to detect anomalous transactions or components thereof. Automatic baselining for a selected metric is provided using variability based on a distribution range and arithmetic mean of actual performance data to determine an appropriate sensitivity for boundaries between comparison levels. A user-defined sensitivity parameter allows adjustment of baselines to increase or decrease comparison sensitivity for a selected metric. The system identifies anomalies in transactions, or components of transaction based on a comparison of actual performance data with the automatically determined baseline for a corresponding metric. The system reports performance data and other transactional data for identified anomalies.

In one embodiment, a computer-implemented method of determining a normal range of behavior for an application is provided that includes accessing performance data associated with a metric for a plurality of transactions of an application, accessing an initial range multiple for the metric, calculating a variability measure for the metric based on a maximum value, minimum value and arithmetic mean of the performance data, modifying the initial range multiple based on the calculated variability measure for the metric, and automatically establishing a baseline for the metric based on the modified range multiple.

A computer-implemented method in accordance with another embodiment includes monitoring a plurality of transactions associated with an application, generating performance data for the plurality of transactions of the application, the performance data corresponding to a selected metric, establishing a default deviation threshold for the selected metric, modifying the default deviation threshold using a calculated variability measure for the selected metric based on the performance data, automatically establishing a baseline for the selected metric using the modified deviation threshold, comparing the generated performance data for the plurality of transactions to the baseline for the metric, and reporting one or more transactions having performance data outside of the baseline for the selected metric.

In one embodiment, a computer-implemented method is provided that includes accessing performance data associated with a metric of an application, establishing an initial baseline for the metric, modifying the initial baseline based on a calculated variability of the performance data associated with the metric, determining at least one comparison threshold for the metric using the modified baseline for the metric, generating additional performance data associated with the metric of the application, comparing the additional performance data with the at least one comparison threshold, and reporting one or more anomalies associated with the application responsive to the comparing.

Embodiments in accordance with the present disclosure can be accomplished using hardware, software or a combination of both hardware and software. The software can be stored on one or more processor readable storage devices such as hard disk drives, CD-ROMs, DVDs, optical disks, floppy disks, tape drives, RAM, ROM, flash memory or other suitable storage device(s). In alternative embodiments, some or all of the software can be replaced by dedicated hardware including custom integrated circuits, gate arrays, FPGAs, PLDs, and special purpose processors. In one embodiment, software (stored on a storage device) implementing one or more embodiments is used to program one or more processors. The one or more processors can be in communication with one or more storage devices, peripherals and/or communication interfaces.

### BRIEF DESCRIPTION OF THE DRAWINGS

FIG. 1 is a block diagram of a system for monitoring applications and determining transaction performance.

FIG. 2 is a block diagram depicting the instrumentation of byte code by a probe builder

FIG. 3 is a block diagram of a system for monitoring an application.

FIG. 4 is a block diagram of a logical representation of a portion of an agent.

FIG. 5 illustrates a typical computing system for implementing embodiments of the presently disclosed technology.

FIG. 6 is a flowchart describing a process for monitoring applications and determining transaction performance in accordance with one embodiment.

FIG. 7 is a flowchart of a process describing one embodiment for initiating transaction tracing.

FIG. 8 is a flowchart of a process describing one embodiment for concluding transaction tracing.

FIG. 9 is a flowchart of a process describing one embodiment of application performance monitoring including automatic baselining of performance metrics.

FIG. 10 is a flowchart of a process describing one embodiment for automatic baselining of performance metrics using calculated variability.

FIG. 11 is a flowchart of a process describing one embodiment for calculating metric variability.

FIG. 12 is a flowchart of a process describing one embodiment for establishing metric baselines using variability-modified range multiples.

FIG. 13 is a flowchart of a process describing one embodiment for reporting anomalous events.

FIG. 14 is a flowchart of a process describing one embodiment for providing report data to a user.

### DETAILED DESCRIPTION

An application monitoring system monitors one or more applications to generate and report application performance data for transactions. Actual performance data for a metric is compared with a corresponding baseline metric value to detect anomalous transactions and components thereof. Automatic baselining for a selected metric is provided using variability based on a distribution range and arithmetic mean of actual performance data to determine an appropriate sensitivity for boundaries between comparison levels. A user-defined sensitivity parameter allows adjustment of baselines to increase or decrease comparison sensitivity for a selected metric. The system identifies anomalies in transactions and components of transactions based on a comparison of actual performance data with the automatically determined baseline for a corresponding metric. The system reports performance data and other transactional data for identified anomalies.

Anomalous transactions can be automatically determined using the baseline metrics. An agent is installed on an application server or other machine which performs a transaction in one embodiment. The agent receives monitoring data from monitoring code within an application that performs the transaction and determines a baseline for the transaction. The actual transaction performance is then compared to baseline metric values for transaction performance for each transaction. The agent can identify anomalous transactions based on the comparison and configuration data received from an application monitoring system. After the agent identifies anomalous transactions, information for the identified transactions is automatically reported to a user. The reported information may include rich application transaction information, including the performance and structure of components that comprise the application, for each anomaly transaction. One or more of the foregoing operations can be performed by a centralized or distributed enterprise manager in combination with the agents.

In one embodiment, the performance data is processed and reported as deviation information based on a deviation range for actual data point values. A number of deviation ranges can be generated based on a baseline metric value. The actual data point will be contained in one of the ranges. The deviation associated with the range is proportional to how far the range is from the predicted value. An indication of which range contains the actual data point value may be presented to a user through an interface and updated as different data points in the time series are processed.

A baseline for a selected metric is established automatically using actual performance data. The baseline can be dynamically updated based on data received over time. Absolute notions of metric variability are included in baseline determinations in addition to standard measurements of distribution spread. Considerations of metric variability allow more meaningful definitions of normal metric performance or behavior to be established. For example, incorporating variability allows the definition of normal behavior to include or focus on real-world human sensitivity to delays and variation. The inclusion of measured variability combines absolute deviation and relative deviation to dynamically determine normal values for application diagnostic metrics. These normal values can be established as baseline metrics such as a comparison threshold around a calculated average or mean in one example.

In one embodiment, an initial range multiple is defined for a selected metric. By way of non-limiting example, the range multiple may be a number of standard deviations from a calculated average or mean. The initial range multiple may be a default value or may be a value determined from past performance data for the corresponding metric. More than one range multiple can be defined to establish different comparison intervals for classifying application or transaction performance. For example, a first range multiple may define a first z-score or number of deviations above and/or below an average value and a second range multiple may define a second z-score or number of deviations further above and/or below the average value than the first z-score. Transactions falling outside the first range multiple may be considered abnormal and transactions falling outside the second range multiple may be considered very abnormal. Other designations may be used.

Using actual performance data, a variability of the selected metric is calculated, for example, by combining the range of the metric's distribution with its arithmetic mean. Generally, a fairly constant distribution having a narrow range will have a low variability if its mean is relatively large. If the metric is distributed widely compared to its average value, it will have a large variability. The calculated variability can be combined with the initial range multiples such that the comparison sensitivity is increased for more variable distributions and decreased for more constant distributions. The adjusted range multiple is combined with the standard deviation of the metric distribution to determine baseline metrics, such as comparison thresholds.

Response time, error rate, throughput, and stalls are examples of the many metrics that can be monitored, processed and reported using the present technology. Other examples of performance metrics that can be monitored, processed and reported include, but are not limited to, method timers, remote invocation method timers, thread counters, network bandwidth, servlet timers, Java Server Pages timers, systems logs, file system input and output bandwidth meters, available and used memory, Enterprise JavaBean timers, and other measurements of other activities. Other metrics and data may be monitored, processed and reported as well, including connection pools, thread pools, CPU utilization, user roundtrip response time, user visible errors, user visible stalls, and others. In various embodiments, performance metrics for which normality is generally accepted to be a combination of relative and absolute measures undergo automatic baselining using variability of the metric distribution.

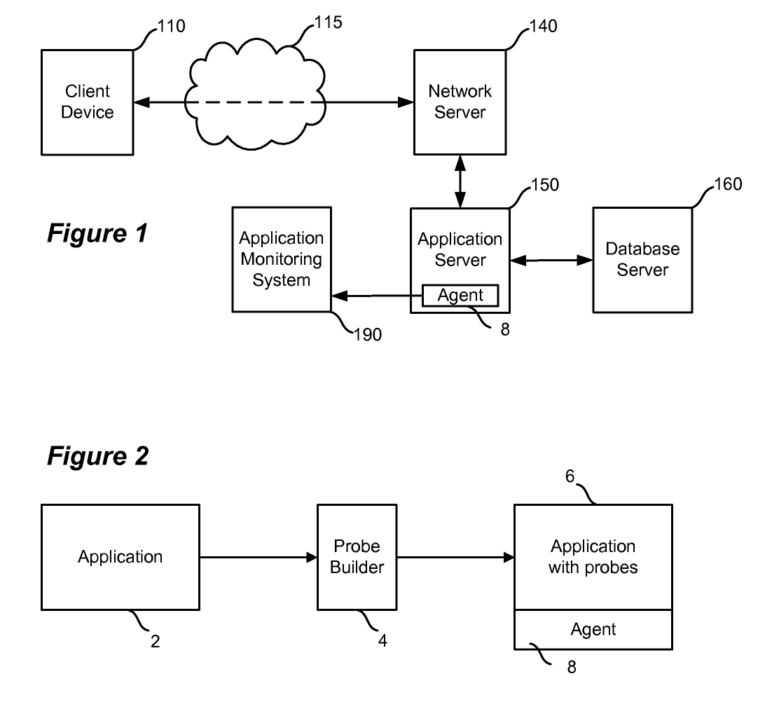

FIG. 1 is a block diagram depicting one embodiment of a system for monitoring applications and determining transaction performance. A client device 110 and network server 140 communicate over network 115, such as by the network server 140 sending traffic to and receiving traffic from client device 110. Network 115 can be any public or private network over which the client device and network sever communicate, including but not limited to the Internet, other WAN, LAN, intranet, extranet, or other network or networks. In practice, a number of client devices can communicate with the network server 140 over network 115 and any number of servers or other computing devices which are connected in any configuration can be used.

Network server 140 may provide a network service to client device 110 over network 115. Application server 150 is in communication with network server 140, shown locally, but can also be connected over one or more networks. When network server 140 receives a request from client device 110, network server 140 may relay the request to application server 150 for processing. Client device 110 can be a laptop, PC, workstation, cell phone, PDA, or other computing device which is operated by an end user. The client device may also be an automated computing device such a server. Application server 150 processes the request received from network server 140 and sends a corresponding response to the client device 110 via the network server 140. In some embodiments, application server 150 may send a request to database server 160 as part of processing a request received from network server 140. Database server 160 may provide a database or some other backend service and process requests from application server 150

The monitoring system of FIG. 1 includes application monitoring system 190. In some embodiments, the application monitoring system uses one or more agents, such as agent 8, which is considered part of the application monitoring system 190, though it is illustrated as a separate block in FIG. 1. Agent 8 and application monitoring system 190 monitor the execution of one or more applications at the application server 150, generate performance data representing the execution of components of the application responsive to the requests, and process the generated performance data. In some embodiments, application monitoring system 190 may be used to monitor the execution of an application or other code at some other server, such as network server 140 or backend database server 160.

Performance data, such as time series data corresponding to one or more metrics, may be generated by monitoring an application using bytecode instrumentation. An application management tool, not shown but part of application monitoring system 190 in one example, may instrument the application's object code (also called bytecode). FIG. 2 depicts a process for modifying an application's bytecode. Application 2 is an application before instrumentation to insert probes. Application 2 is a Java application in one example, but other types of applications written in any number of languages may be similarly instrumented. Application 6 is an instrumented version of Application 2, modified to include probes that are used to access information from the application.

Probe Builder 4 instruments or modifies the bytecode for Application 2 to add probes and additional code to create Application 6. The probes may measure specific pieces of information about the application without changing the application's business or other underlying logic. Probe Builder 4 may also generate one or more Agents 8. Agents 8 may be installed on the same machine as Application 6 or a separate machine. Once the probes have been installed in the application bytecode, the application may be referred to as a managed application. More information about instrumenting byte code can be found in U.S. Pat. No. 6,260,187 “System For Modifying Object Oriented Code” by Lewis K. Cirne, incorporated herein by reference in its entirety.

One embodiment instruments bytecode by adding new code. The added code activates a tracing mechanism when a method starts and terminates the tracing mechanism when the method completes. To better explain this concept, consider the following example pseudo code for a method called “exampleMethod.” This method receives an integer parameter, adds 1 to the integer parameter, and returns the sum:

public int
exampleMethod(int x)

{
return x + 1;
}

In some embodiments, instrumenting the existing code conceptually includes calling a tracer method, grouping the original instructions from the method in a “try” block and adding a “finally” block with a code that stops the tracer. An example is below which uses the pseudo code for the method above.

public int
exampleMethod(int x)

{
IMethodTracer tracer = AMethodTracer.loadTracer(

“com.introscope.agenttrace.MethodTimer”,
this,
“com.wily.example.ExampleApp”,
“exampleMethod”,
“name=Example Stat”);

| | |
|---|---|
| try | { |

| return x + 1; | |
|---|---|
| } finally | { |

tracer.finishTrace( );
}

}

IMethodTracer is an interface that defines a tracer for profiling. AMethodTracer is an abstract class that implements IMethodTracer. IMethodTracer includes the methods startTrace and finishTrace. AMethodTracer includes the methods startTrace, finishTrace, dostartTrace and dofinishTrace. The method startTrace is called to start a tracer, perform error handling and perform setup for starting the tracer. The actual tracer is started by the method doStartTrace, which is called by startTrace. The method finishTrace is called to stop the tracer and perform error handling. The method finishTrace calls doFinishTrace to actually stop the tracer. Within AMethodTracer, startTrace and finishTracer are final and void methods; and doStartTrace and doFinishTrace are protected, abstract and void methods. Thus, the methods doStartTrace and do FinishTrace must be implemented in subclasses of AMethodTracer. Each of the subclasses of AMethodTracer implement the actual tracers. The method loadTracer is a static method that calls startTrace and includes five parameters. The first parameter, “com.introscope . . . ” is the name of the class that is intended to be instantiated that implements the tracer. The second parameter, “this” is the object being traced. The third parameter “com.wily.example . . . ” is the name of the class that the current instruction is inside of. The fourth parameter, “exampleMethod” is the name of the method the current instruction is inside of. The fifth parameter, “name= . . . ” is the name to record the statistics under. The original instruction (return x+1) is placed inside a “try” block. The code for stopping the tracer (a call to the static method tracer.finishTrace) is put within the finally block.

The above example shows source code being instrumented. In some embodiments, the present technology doesn't actually modify source code, but instead, modifies object code. The source code examples above are used for illustration. The object code is modified conceptually in the same manner that source code modifications are explained above. That is, the object code is modified to add the functionality of the “try” block and “finally” block. More information about such object code modification can be found in U.S. patent application Ser. No. 09/795,901, “Adding Functionality To Existing Code At Exits,” filed on Feb. 28, 2001, incorporated herein by reference in its entirety. In another embodiment, the source code can be modified as explained above.

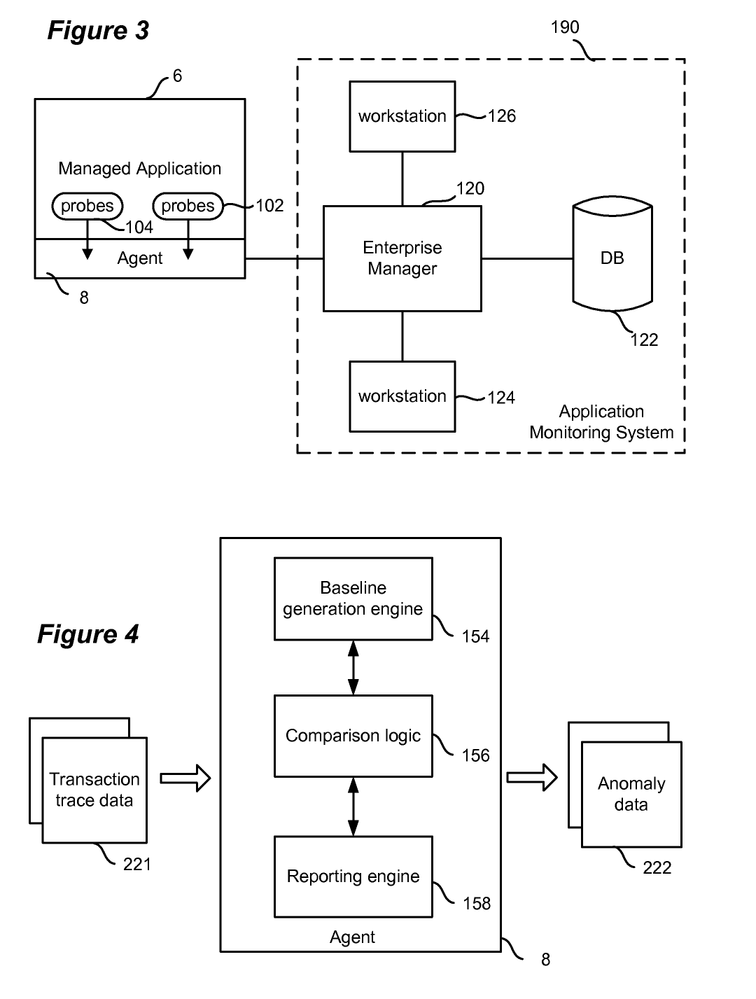

FIG. 3 is a block diagram depicting a conceptual view of the components of an application performance management system. Managed application 6 is depicted with inserted probes 102 and 104, communicating with application monitoring system 190 via agent 8. The application monitoring system 190 includes enterprise manager 120, database 122, workstation 124 and workstation 126. As managed application 190 runs, probes 102 and/or 104 relay data to agent 8, which collects the received data, processes and optionally summarizes the data, and sends it to enterprise manager 120. Enterprise manager 120 receives performance data from the managed application via agent 8, runs requested calculations, makes performance data available to workstations (e.g. 124 and 126) and optionally sends performance data to database 122 for later analysis. The workstations 124 and 126 include a graphical user interface for viewing performance data and may be used to create custom views of performance data which can be monitored by a human operator. In one embodiment, the workstations consist of two main windows: a console and an explorer. The console displays performance data in a set of customizable views. The explorer depicts alerts and calculators that filter performance data so that the data can be viewed in a meaningful way. The elements of the workstation that organize, manipulate, filter and display performance data include actions, alerts, calculators, dashboards, persistent collections, metric groupings, comparisons, smart triggers and SNMP collections.

In one embodiment of the system of FIG. 3, each of the components run on different physical or virtual machines. Workstation 126 is on a first computing device, workstation 124 is on a second computing device, enterprise manager 120 is on a third computing device, and managed application 6 is on a fourth computing device. In another embodiment, two or more (or all) of the components may operate on the same physical or virtual machine. For example, managed application 6 and agent 8 may be on a first computing device, enterprise manager 120 on a second computing device and a workstation on a third computing device. Alternatively, all of the components of FIG. 3 can run on the same computing device. Any or all of these computing devices can be any of various different types of computing devices, including personal computers, minicomputers, mainframes, servers, handheld computing devices, mobile computing devices, etc. Typically, these computing devices will include one or more processors in communication with one or more processor readable storage devices, communication interfaces, peripheral devices, etc. Examples of the storage devices include RAM, ROM, hard disk drives, floppy disk drives, CD ROMS, DVDs, flash memory, etc. Examples of peripherals include printers, monitors, keyboards, pointing devices, etc. Examples of communication interfaces include network cards, modems, wireless transmitters/receivers, etc. The system running the managed application can include a web server/application server. The system running the managed application may also be part of a network, including a LAN, a WAN, the Internet, etc. In some embodiments, all or part of the system is implemented in software that is stored on one or more processor readable storage devices and is used to program one or more processors.

In some embodiments, a user of the system in FIG. 3 can initiate transaction tracing and baseline determination on all or some of the agents managed by an enterprise manager by specifying trace configuration data. Trace configuration data may specify how traced data is compared to baseline data, for example by specifying a range or sensitivity of the baseline, type of function to fit to past performance data, and other data. All transactions inside an agent whose execution time does not satisfy or comply with a baseline or expected value will be traced and reported to the enterprise manager 120, which will route the information to the appropriate workstations. The workstations have registered interest in the trace information and will present a GUI that lists all transactions that didn't satisfy the baseline, or were detected to be an anomalous transaction. For each listed transaction, a visualization that enables a user to immediately understand where time was being spent in the traced transaction can be provided.

FIG. 4 is a block diagram of a logical representation of a portion of an agent. Agent 8 includes comparison system logic 156, baseline generation engine 154, and reporting engine 158. Baseline generation engine 154 runs statistical models to process the time series of application performance data. For example, to generate a baseline metric, baseline generation engine 154 accesses time series data for a transaction and processes instructions to generate a baseline for the transaction. The time series data is contained in transaction trace data 221 provided to agent 8 by trace code inserted in an application. Baseline generation engine 154 will then generate the solid metric and provide it to comparison system logic 156. Baseline generation engine 154 may also process instructions to fit a time series to a function, update a function based on most recent data points, and other functions.

Comparison system logic 156 includes logic that compares expected data to baseline data. In particular, comparison system logic 156 includes logic that carries out processes as discussed below. Reporting engine 158 may identify flagged transactions, generate a report package, and transmit a report package having data for each flagged transaction. The report package provided by reporting engine 158 may include anomaly data 222.

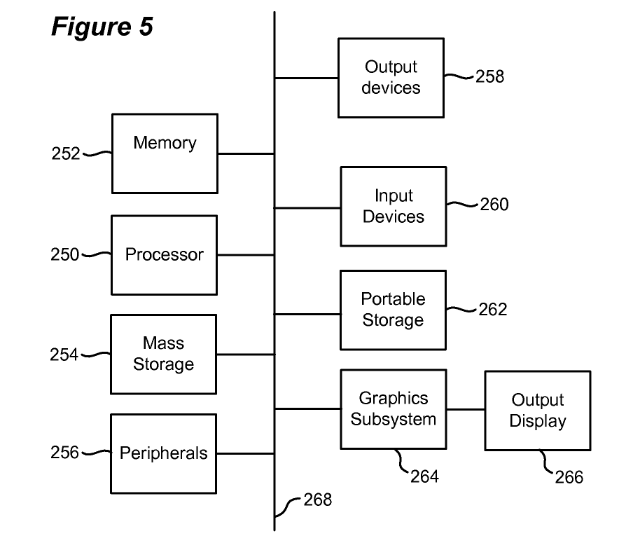

FIG. 5 illustrates an embodiment of a computing system 200 for implementing the present technology. In one embodiment, the system of FIG. 5 may implement Enterprise manager 120, database 122, and workstations 124-126, as well client 110, network server 140, application server 150, and database server 160.

The computer system of FIG. 5 includes one or more processors 250 and main memory 252. Main memory 252 stores, in part, instructions and data for execution by processor unit 250. Main memory 252 can store the executable code when in operation for embodiments wholly or partially implemented in software. The system of FIG. 5 further includes a mass storage device 254, peripheral device(s) 256, user input device(s) 260, output devices 258, portable storage medium drive(s) 262, a graphics subsystem 264 and an output display 266. For purposes of simplicity, the components shown in FIG. 5 are depicted as being connected via a single bus 268. However, the components may be connected through one or more data transport means. For example, processor unit 250 and main memory 252 may be connected via a local microprocessor bus, and the mass storage device 254, peripheral device(s) 256, portable storage medium drive(s) 262, and graphics subsystem 64 may be connected via one or more input/output (I/O) buses. Mass storage device 254, which may be implemented with a magnetic disk drive or an optical disk drive, is a non-volatile storage device for storing data and instructions for use by processor unit 250. In one embodiment, mass storage device 254 stores system software for implementing embodiments for purposes of loading to main memory 252.

Portable storage medium drive 262 operates in conjunction with a portable non-volatile storage medium, such as a floppy disk, to input and output data and code to and from the computer system of FIG. 5. In one embodiment, the system software is stored on such a portable medium, and is input to the computer system via the portable storage medium drive 262. Peripheral device(s) 256 may include any type of computer support device, such as an input/output (I/O) interface, to add additional functionality to the computer system. For example, peripheral device(s) 256 may include a network interface for connecting the computer system to a network, a modem, a router, etc.

User input device(s) 260 provides a portion of a user interface. User input device(s) 260 may include an alpha-numeric keypad for inputting alpha-numeric and other information, or a pointing device, such as a mouse, a trackball, stylus, or cursor direction keys. In order to display textual and graphical information, the computer system of FIG. 3 includes graphics subsystem 264 and output display 266. Output display 266 may include a cathode ray tube (CRT) display, liquid crystal display (LCD) or other suitable display device. Graphics subsystem 264 receives textual and graphical information, and processes the information for output to display 266. Additionally, the system of FIG. 5 includes output devices 258. Examples of suitable output devices include speakers, printers, network interfaces, monitors, etc.

The components contained in the computer system of FIG. 5 are those typically found in computer systems suitable for use with embodiments of the present disclosure, and are intended to represent a broad category of such computer components that are well known in the art. The computer system of FIG. 5 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

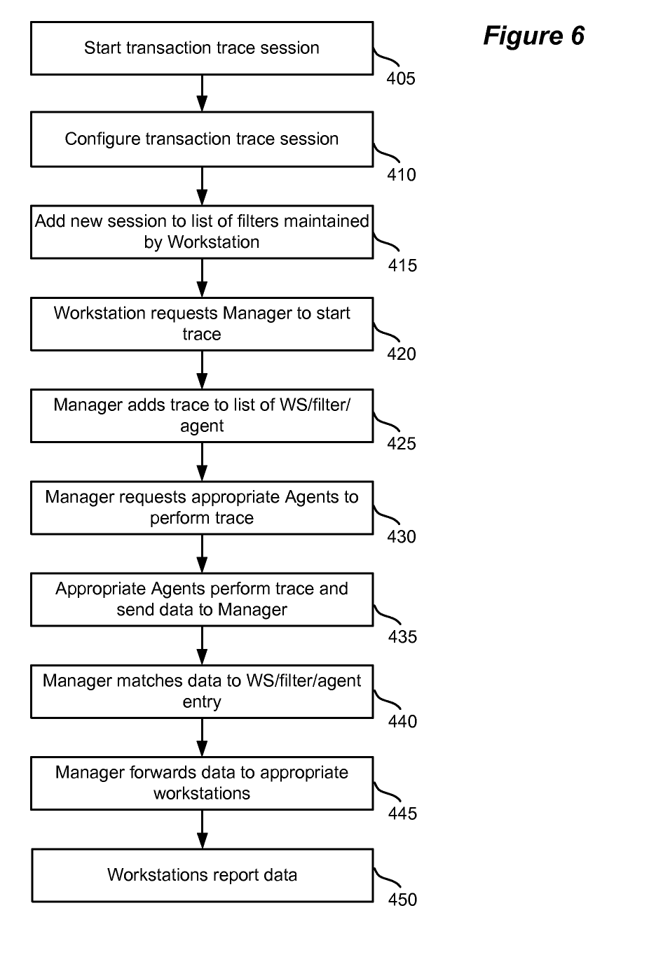

FIG. 6 is a flowchart describing one embodiment of a process for tracing transactions using a system as described in FIGS. 1-4. For example, FIG. 6 describes the operation of application monitoring system 190 and agent 152 according to one embodiment. A transaction trace session is started at step 405, for example, in response to a user opening a window in a display provided at a workstation and selecting a dropdown menu to start the transaction trace session. In other embodiments, other methods can be used to start the session.

A trace session is configured for one or more transactions at step 410. Configuring a trace may be performed at a workstation within application monitoring system 190. Trace configuration may involve identifying one or more transactions to monitor, one or more components within an application to monitor, selecting a sensitivity parameter for a baseline to apply to transaction performance data, and other information. The transaction trace session is typically configured with user input but may be automated in other examples. Eventually, the configuration data is transmitted to an agent 152 within an application server by application monitoring system 190.

In some embodiments, a dialog box or other interface is presented to the user. This dialog box or interface will prompt the user for transaction trace configuration information. The configuration information is received from the user through a dialogue box or other interface element. Other means for entering the information can also be used within the spirit of the present invention.

Several configuration parameters may be received from or configured by a user, including a baseline. A user may enter a desired comparison threshold or range parameter time, which could be in seconds, milliseconds, microseconds, etc. When analyzing transactions for response time, the system will report those transactions that have an execution time that does not fall within the comparison threshold with respect to a baseline value. For example, if the comparison threshold is one second and the detected baseline is three seconds, the system will report transactions that are executing for shorter than two seconds or longer than four seconds, which are outside the range of the baseline plus or minus the threshold.

In some embodiments, other configuration data can also be provided. For example, the user can identify an agent, a set of agents, or all agents, and only identified agents will perform the transaction tracing described herein. In some embodiments, enterprise manager 120 will determine which agents to use. Another configuration variable that can be provided is the session length. The session length indicates how long the system will perform the tracing. For example, if the session length is ten minutes, the system will only trace transactions for ten minutes. At the end of the ten minute period, new transactions that are started will not be traced; however, transactions that have already started during the ten minute period will continue to be traced. In other embodiments, at the end of the session length all tracing will cease regardless of when the transaction started. Other configuration data can also include specifying one or more userIDs, a flag set by an external process or other data of interest to the user. For example, the userID is used to specify that the only transactions initiated by processes associated with a particular one, or more userIDs will be traced. The flag is used so that an external process can set a flag for certain transactions, and only those transactions that have the flag set will be traced. Other parameters can also be used to identify which transactions to trace. In one embodiment, a user does not provide a threshold, deviation, or trace period for transactions being traced. Rather, the application performance management tool intelligently determines the threshold(s).

At step 415, the workstation adds the new filter to a list of filters on the workstation. In step 420, the workstation requests enterprise manager 120 to start the trace using the new filter. In step 425, enterprise manager 120 adds the filter received from the workstation to a list of filters. For each filter in its list, enterprise manager 120 stores an identification of the workstation that requested the filter, the details of the filter (described above), and the agents to which the filter applies. In one embodiment, if the workstation does not specify the agents to which the filter applies, then the filter will apply to all agents. In step 430, enterprise manager 120 requests the appropriate agents to perform the trace. In step 435, the appropriate agents perform the trace and send data to enterprise manager 120. More information about steps 430 and 435 will be provided below. In step 440, enterprise manager 120 matches the received data to the appropriate workstation/filter/agent entry. In step 445, enterprise manager 120 forwards the data to the appropriate workstation(s) based on the matching in step 440. In step 450, the appropriate workstations report the data. In one embodiment, the workstation can report the data by writing information to a text file, to a relational database, or other data container. In another embodiment, a workstation can report the data by displaying the data in a GUI. More information about how data is reported is provided below.

When performing a trace of a transaction in one example, one or more Agents 8 perform transaction tracing using Blame technology. Blame Technology works in a managed Java Application to enable the identification of component interactions and component resource usage. Blame Technology tracks components that are specified to it using concepts of consumers and resources. A consumer requests an activity while a resource performs the activity. A component can be both a consumer and a resource, depending on the context in how it is used.

An exemplary hierarchy of transaction components is now discussed. An Agent may build a hierarchical tree of transaction components from information received from trace code within the application performing the transaction. When reporting about transactions, the word Called designates a resource. This resource is a resource (or a sub-resource) of the parent component, which is the consumer. For example, under the consumer Servlet A (see below), there may be a sub-resource Called EJB. Consumers and resources can be reported in a tree-like manner. Data for a transaction can also be stored according to the tree. For example, if a Servlet (e.g. Servlet A) is a consumer of a network socket (e.g. Socket C) and is also a consumer of an EJB (e.g. EJB B), which is a consumer of a JDBC (e.g. JDBC D), the tree might look something like the following:

Servlet A

Data for Servlet A

Called EJB B

Data for EJB B

Called JDBC D

Data for JDBC D

Called Socket C

Data for Socket C

In one embodiment, the above tree is stored by the Agent in a stack called the Blame Stack. When transactions are started, they are added to or “pushed onto” the stack. When transactions are completed, they are removed or “popped off” the stack. In some embodiments, each transaction on the stack has the following information stored: type of transaction, a name used by the system for that transaction, a hash map of parameters, a timestamp for when the transaction was pushed onto the stack, and sub-elements. Sub-elements are Blame Stack entries for other components (e.g. methods, process, procedure, function, thread, set of instructions, etc.) that are started from within the transaction of interest. Using the tree as an example above, the Blame Stack entry for Servlet A would have two sub-elements. The first sub-element would be an entry for EJB B and the second sub-element would be an entry for Socket Space C. Even though a sub-element is part of an entry for a particular transaction, the sub-element will also have its own Blame Stack entry. As the tree above notes, EJB B is a sub-element of Servlet A and also has its own entry. The top (or initial) entry (e.g., Servlet A) for a transaction is called the root component. Each of the entries on the stack is an object. While the embodiment described herein includes the use of Blame technology and a stack, other embodiments of the present invention can use different types of stack, different types of data structures, or other means for storing information about transactions. More information about blame technology and transaction tracing can be found in U.S. patent application Ser. No. 10/318,272, “Transaction Tracer,” filed on Dec. 12, 2002, incorporated herein by reference in its entirety.

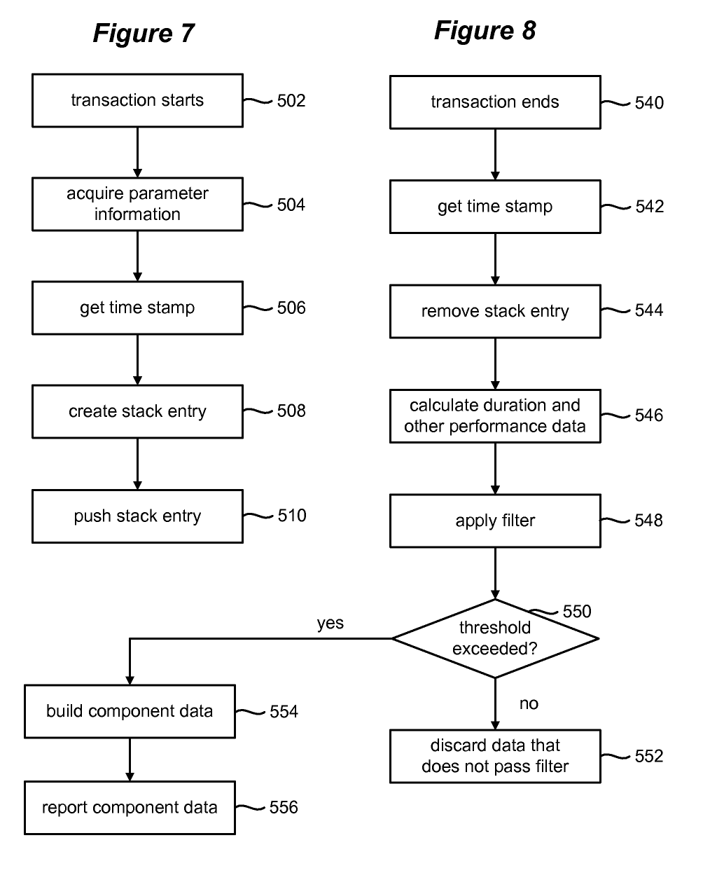

FIG. 7 is a flowchart describing one embodiment of a process for starting the tracing of a transaction. The steps of FIG. 7 are performed by the appropriate agent(s). In step 502, a transaction starts. In one embodiment, the process is triggered by the start of a method as described above (e.g. the calling of the “loadTracer” method). In other embodiments, other methods can be used to start the session. In some embodiments, when a transaction to be monitored begins, the transaction trace is triggered by code inserted in the application.

In step 504, the agent acquires the desired parameter information. In one embodiment, a user can configure which parameter information is to be acquired via a configuration file or the GUI. The acquired parameters are stored in a hash map, which is part of the object pushed onto the Blame Stack. In other embodiments, the identification of parameters are pre-configured. There are many different parameters that can be stored. In some embodiments, the actual list of parameters used is dependent on the application being monitored. Some parameters that may be obtained and stored include UserID, URL, URL Query, Dynamic SQL, method, object, class name, and others. In one embodiment, the actual list of parameters used is dependent on the application being monitored. The present disclosure is not limited to any particular set of parameters.

In step 506, the system acquires a timestamp indicating the current time. In step 508, a stack entry is created. In step 510, the stack entry is pushed onto the Blame Stack. In one embodiment, the timestamp is added as part of step 510. The process of FIG. 7 is performed when a transaction is started. A process similar to that of FIG. 7 is performed when a component of the transaction starts (e.g. EJB B is a component of Servlet A—see tree described above).

A timestamp is retrieved or acquired at step 506. The time stamp indicates the time at which the transaction or particular component was pushed onto the stack. After retrieving the time stamp, a stack entry is created at step 508. In some embodiments, the stack entry is created to include the parameter information acquired at step 504 as well as the time stamp retrieved at step 506. The stack entry is then added or “pushed onto” the Blame Stack at step 510. Once the transaction completes, a process similar to that of FIG. 7 is performed when a sub-component of the transaction starts (for example, EJB B is a sub-component of Servlet A—see tree described above). As a result, a stack entry is created and pushed onto the stack as each component begins. As each component and eventually the entire transaction ends, each stack entry is removed from the stack. The resulting trace information can then be assembled for the entire transaction with component level detail.

FIG. 8 is a flowchart describing one embodiment of a process for concluding the tracing of a transaction. The process of FIG. 8 can be performed by an agent when a transaction ends. In step 540, the process is triggered by a transaction (e.g. method) ending as described above (e.g. calling of the method “finishTrace”). In step 542, the system acquires the current time. In step 544, the stack entry is removed. In step 546, the execution time of the transaction is calculated by comparing the timestamp from step 542 to the timestamp stored in the stack entry. In step 548, the filter for the trace is applied. For example, the filter may include a threshold execution time. If the threshold is not exceeded (step 550), then the data for the transaction is discarded. In one embodiment, the entire stack entry is discarded. In another embodiment, only the parameters and timestamps are discarded. In other embodiments, various subsets of data can be discarded. In some embodiments, if the threshold is not exceeded then the data is not transmitted by the agent to other components in the system. If the duration exceeds the threshold (step 550), then the agent builds component data in step 554. Component data is the data about the transaction that will be reported. In one embodiment, the component data includes the name of the transaction, the type of the transaction, the start time of the transaction, the duration of the transaction, a hash map of the parameters, and all of the sub-elements or components of the transaction (which can be a recursive list of elements). Other information can also be part of the component data. In step 556, the agent reports the component data by sending the component data via the TCP/IP protocol to enterprise manager 120.

FIG. 8 represents what happens when a transaction finishes. When a component finishes, the steps can include getting a time stamp, removing the stack entry for the component, and adding the completed sub-element to previous stack entry. In one embodiment, the filters and decision logic are applied to the start and end of the transaction, rather than to a specific component.

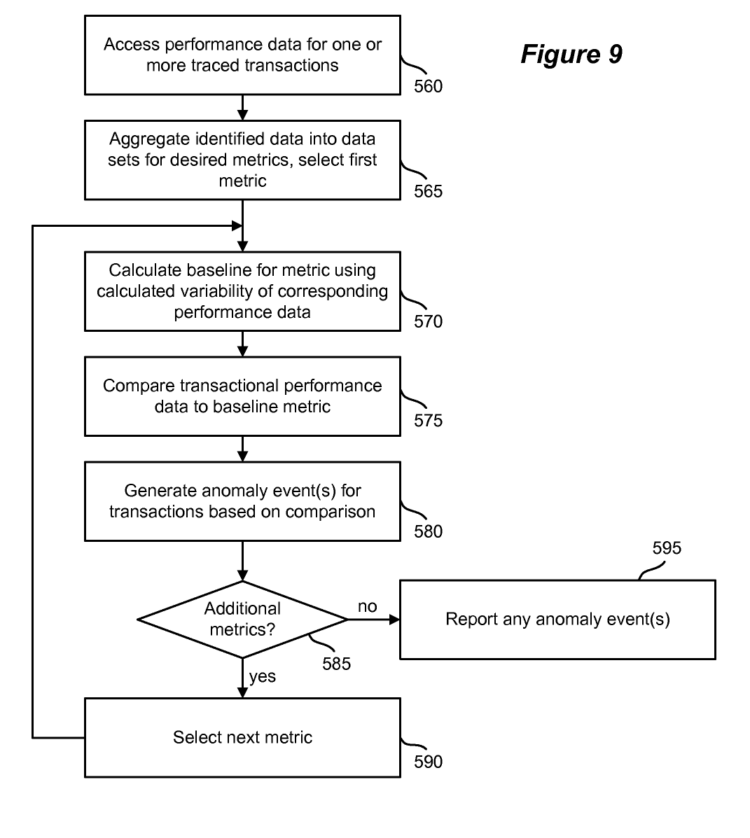

FIG. 9 is a flowchart describing one embodiment for automatically and dynamically establishing baseline metrics and using the baselines to detect anomalies during application performance monitoring. In one example, operation of FIG. 9 can be performed as part of tracing and matching data at steps 435 and 440 of FIG. 6. The various processes of FIG. 9 can be performed by the enterprise manager or agents or by combinations of the two. Baseline metrics such as response times, error counts and/or CPU loads, and associated deviation ranges can be automatically generated and updated periodically. In some cases, the metrics can be correlated with transactions as well. Further, the baseline metrics and deviations ranges can be established for an entire transaction, e.g., as a round trip response time, as well as for portions of a transaction, whether the transaction involves one or more hosts and one or more processes at the one or more hosts. In some cases, a deviation range is not needed, e.g., when the baseline metric is a do not exceed level. For example, only response times, error counts or CPU loads which exceed a baseline value may be considered to be anomalous. In other cases, only response times, error counts or CPU loads which are below a baseline value are considered to be anomalous. In yet other cases, response times, error counts or CPU loads which are either too low or too high are considered to be anomalous.

Performance data for one or more traced transactions is accessed at step 560. In one possible approach, initial transaction data and metrics are received from agents at the hosts. For example, this information may be received by the enterprise manager over a period of time which is used to establish the baseline metrics. In another possible approach, initial baseline metrics are set, e.g., based on a prior value of the metric or an administrator input, and subsequently periodically updated automatically.

The performance data may be accessed from agent 105 by enterprise manager 120. Performance data associated with a desired metric is identified. In one embodiment, enterprise manager 120 parses the received performance data and identifies a portion of the performance data to be processed.

The performance data may be a time series of past performance data associated with a recently completed transaction or component of a transaction The time series may be received as a first group of data in a set of groups that are received periodically. For example, the process of identifying anomalous transactions may be performed periodically, such as every five, ten or fifteen seconds. The time series of data may be stored by the agents, representing past performance of one or more transactions being analyzed. For example, the time series of past performance data may represent response times for the last 50 invocations, the invocations in the last fifteen seconds, or some other set of invocations for the particular transaction.

In some embodiments, if there are multiple data points for a given data type, the data is aggregated as shown at step 565. The particular aggregation function may differ according to the data type being aggregated. For example, multiple response time data points are averaged together while multiple error rate data points are summed. In some embodiments, there is one data set per application. Thus, if there is aggregated data for four different applications, there will be four data sets. The data set may comprise a time series of data, such as a series of response times that take place over time. In some embodiments, the data sets may be aggregated by URL rather than application, with one dataset per URL.

The metrics can be correlated with transactions, although this is not always necessary. After selecting a first metric, a baseline is calculated at step 570 using a calculated variability of the performance data corresponding to the selected first metric. Different baselines for metrics can be used in accordance with different embodiments. In one embodiment, standard deviations can be used to establish comparison intervals for determining whether performance data is outside one or more normal ranges. For instance, a transaction having a metric a specified number of standard deviations away from the average for the metric may be considered anomalous. Multiple numbers of standard deviations (also referred to as z-score) may be established to further refine the degree of reporting for transactions. By way of example, a first number of standard deviations from average may be used to classify a transaction as abnormal while a second number may used to classify a transaction as highly abnormal. Initial baseline measures can be established by a user or automatically determined after a number of transactions.

The baseline metrics can be deviation ranges set as a function of the response time, error count or CPU load, for instance, e.g., as a percentage, a standard deviation, or so forth. Further, the deviation range can extend above and/or below the baseline level. As an example, a baseline response time for a transaction may be 1 sec. and the deviation range may be +/−0.2 sec. Thus, a response time in the range of 0.8-1.2 sec, would be considered normal, while a response time outside the range would be considered anomalous.

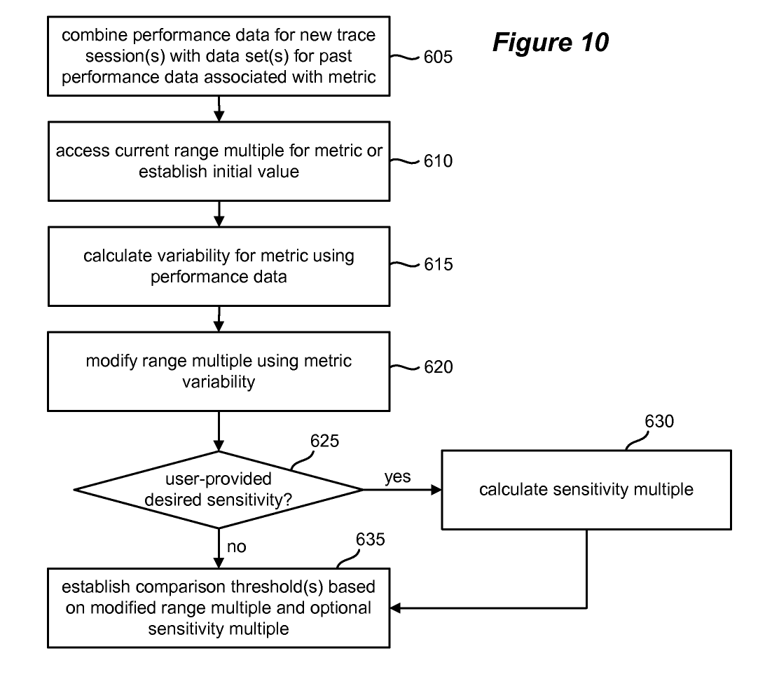

The calculated variability used to determine a baseline metric facilitates smoothing or tempering of deviations (e.g., a number of standard deviations) used to define sensitivity boundaries for normality. In one embodiment, the range of the distribution is combined with its arithmetic mean to determine the appropriate sensitivity to boundaries between comparison intervals as further explained in FIG. 10. Various other techniques may be used to calculate or otherwise identify a variability for the selected metric. Where interquatile ranges or similar methods of defining distributions are used, a smoothing technique can be applied.

A metric having a fairly constant distribution (i.e., having a narrow range) will have a low variability if its mean is relatively large. By contrast, a metric having a larger distribution (i.e., having a wider range) compared with its average value will have a large variability. By introducing the variability of a metric into the determination of baseline values, more valuable indications of normality can be achieved. Using the variability in defining a baseline value increases the comparison sensitivity for metrics having more variable distributions and decreases the comparison sensitivity for metrics having more constant distributions.

After calculating the baseline for the metric, the transaction performance data is compared to the baseline metric at step 575. At this step, performance data generated from information received from the transaction trace and compared to the baseline dynamically determined at step 570.

After comparing the data, an anomaly event may be generated based on the comparison if needed at step 580. Thus, if the comparison of the actual performance data and baseline metric value indicates that transaction performance was an anomaly, an anomaly event may be generated. In some embodiments, generating an anomaly event includes setting a flag for the particular transaction. Thus, if the actual performance of a transaction was slower or faster than expected within a particular range, a flag may be set which identified the transaction instance. The flag for the transaction may be set by comparison logic 156 within agent 152.

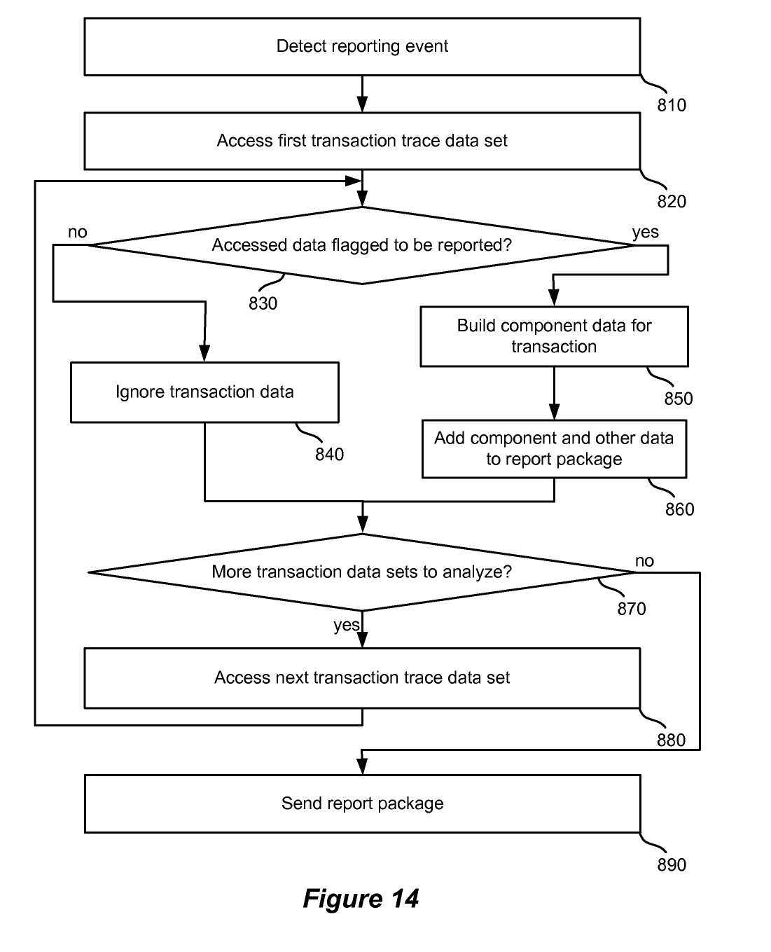

At step 585, the enterprise manger determines if there are additional metrics against which the performance data should be compared. If there are additional metrics to be evaluated, the next metric is selected at step 590 and the method returns to step 570 to calculate its baseline. If there are no additional metrics to be evaluated, anomaly events may be reported at step 490. In some embodiments, anomaly events are reported based on a triggering event, such as the expiration of an internal timer, a request received from enterprise manager 120 or some other system, or some other event. Reporting may include generating a package of data and transmitting the data to enterprise manager 120. Reporting an anomaly event is discussed in more detail below with respect to FIG. 14.

FIG. 10 is a flowchart describing a technique according to one embodiment for establishing baseline metrics such as comparison thresholds for monitored performance data. In one example, the technique described in FIG. 10 can be used at step 570 of FIG. 9 to calculate one or more baseline metrics.

Performance data for one or more new trace sessions is combined with any data sets for past performance data of the selected metric at step 605 if available. Various aggregation techniques as earlier described can be used. At step 610, the current range multiple for the metric is accessed. The range multiple is a number of standard deviations used as a baseline metric in one implementation. If a current range multiple for the metric is not available, an initial value can be established. Default values can be used in one embodiment.

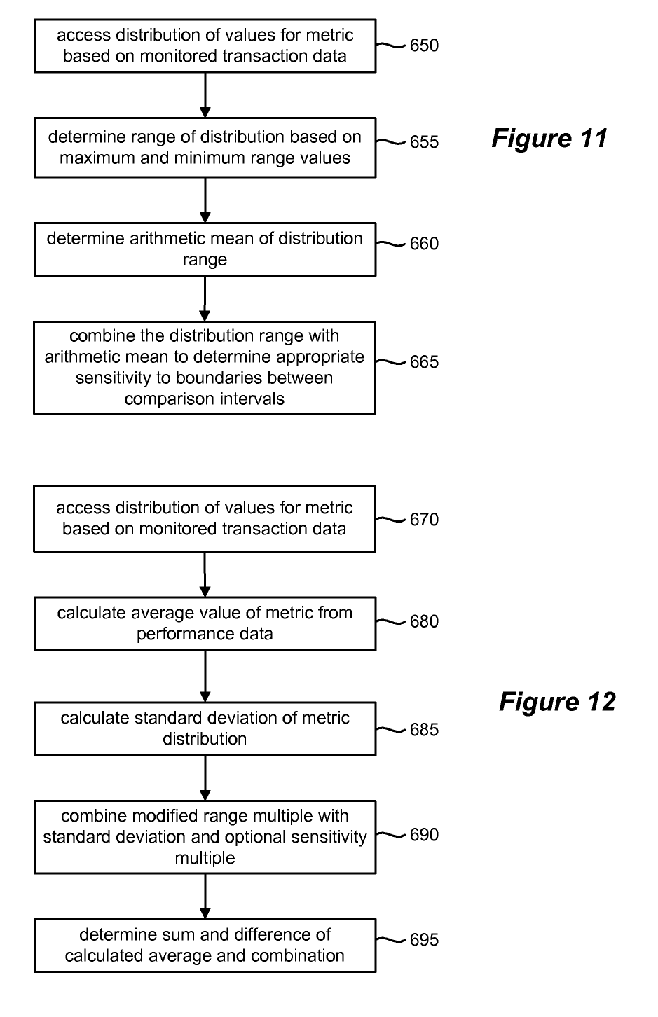

At step 615, the variability of the metric is calculated based on the aggregated performance data. The variability is based on the maximum and minimum values in the distribution of data for the selected metric. A more detailed example is described with respect to FIG. 11. At step 620, the current or initial range multiple is modified using the calculated metric variability. The modified range multiple or other baseline metric provides a way to automatically and dynamically establish a baseline value using measured performance data. The comparison sensitivity for more variable distributions is increased at step 620 while the comparison sensitivity for more constant distributions is decreased. In one embodiment, the initial range multiple is modified according to Equation 1 to determine the modified range multiple value. The difference between the initial range multiple and the calculated variability can be determined for the modified range multiple.

modified_range_multiple=initial_multiple−variability Equation 1

At step 625, the Enterprise Manager determines whether a user provided desired sensitivity parameter is available. A user can indicate a desired level of sensitivity to fine tune the deviation comparisons that are made. By increasing the sensitivity, more transactions or less deviating behavior will be considered abnormal. By lowering the sensitivity, fewer transactions or more deviating behavior will be considered abnormal. If a user has provided a desired sensitivity, a sensitivity multiple is calculated at step 630. Equation 2 sets forth one technique for calculating a sensitivity multiple. A maximum sensitivity and default sensitivity are first established. Various values can be used. For instance, consider an example using a maximum sensitivity of 5 and a default sensitivity of 3 (the mean possible value). The sensitivity multiple can be calculated by determining the difference between the sum of the desired sensitivity and 1, then determining the quotient of this value and the default sensitivity.

$$sensitivity\_multiple = \frac{max\_sensitivity - desired\_sensitivity + 1}{default\_sensitivity} \qquad Equation 2$$

At step 635, one or more comparison thresholds are established based on the modified range multiple and the sensitivity multiple if a user-defined sensitivity parameter was provided. More details regarding establishing comparison thresholds are provided with respect to FIG. 12.

FIG. 11 is a flowchart describing a method for calculating the variability of a distribution of performance data points for a selected metric. In one embodiment, the method of FIG. 11 can be performed at step 615 of FIG. 10.

At step 650, a distribution of values for the selected metric is accessed. The distribution of values is based on monitored transaction data that can be aggregated as described. At step 655, the range of the distribution of values for the metric is determined. The range is calculated using the maximum and minimum values in the distribution, for example, by determining their difference. The arithmetic mean of the distribution of values is determined at step 660. At step 665, the arithmetic mean is combined with the distribution range to determine a final variability value. In one example, step 665 includes determining the quotient of the distribution range and arithmetic mean as shown in Equation 3. In one embodiment, the variability is capped at 1, although this is not required. If the calculated variability is greater than 1, then the variability is set to 1.

$$variability = \frac{distribution\_max - distribution\_min}{arithmetic\_mean} \qquad Equation 3$$

FIG. 12 is a flowchart describing one embodiment of a method for establishing comparison thresholds based on a modified range multiple. In one example, the method of FIG. 12 can be performed at step 635 of FIG. 10. The distribution of values for the selected metric are accessed at step 670, and at step 680, the average value of the metric is calculated. At step 685, the standard deviation of the metric distribution is calculated using standard statistical techniques. At step 690, the modified range multiple determined at step 620 in FIG. 10 is combined with the standard deviation. In one embodiment, step 690 includes taking the product of the standard deviation and modified range multiple. If a user-defined sensitivity parameter is provided, the calculated sensitivity multiple is combined with the modified range multiple and standard deviation, such as by taking the product of the three values. At step 695, the comparison threshold(s) are determined. The comparison thresholds may be established as threshold values based on the average or mean of the metric distribution as set forth in Equation 4.

thresholds=avg±(sens mult*modified range mult*standard dev) Equation 4

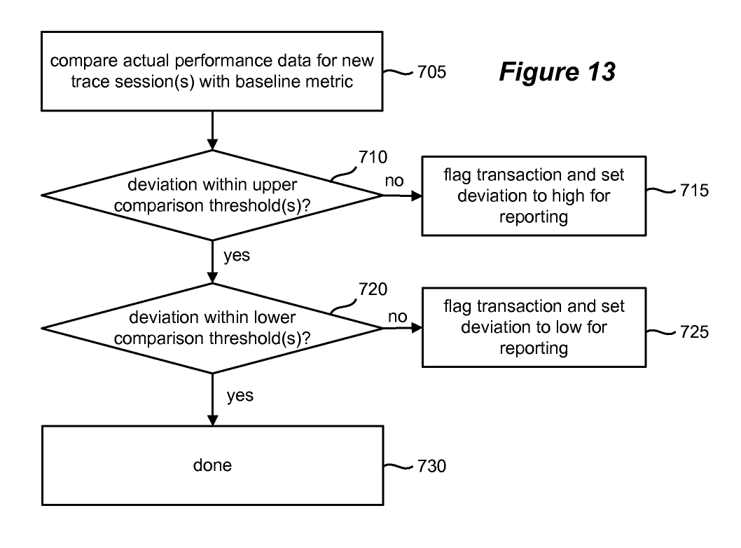

FIG. 13 is a flowchart of a process describing one embodiment for comparing transaction performance data. In one embodiment, the method of FIG. 13 may be performed by agent 8 or the application monitoring system 190 generally at step 475 of FIG. 9. At step 705, the actual performance data from a new trace session is compared with the baseline for the selected metric. The actual performance data may be determined based on information provided to agent 8 by tracing code within an application. For example, tracing code may provide times stamps associated with the start and end of a transaction. From the time stamps, performance data such as the response time may be determined and used in the comparison at step 705. The baseline metric may be comparison thresholds calculated using variability of the metric distribution as described in FIG. 10 in one embodiment.

At step 710, the system determines if the actual performance data, such as a data point in the metric distribution, is within the upper comparison threshold(s) for the selected metric. If the actual data is within the upper limits, the system determines if the actual data is within the lower comparison threshold(s) for the selected metric at step 720. If the actual data is within the lower limits, the process completes at step 730 for the selected metric without flagging any anomalies. If the actual data is not within the upper comparison threshold(s) at step 710, the corresponding transaction is flagged at step 715 with an indication that the deviation is high for that transaction. If the actual data is within the upper comparison threshold(s) but not the lower comparison threshold(s), the transaction is flagged at step 725 with an indication that the deviation is low for that transaction.

The method of FIG. 13 may be performed for each completed transaction, either when the transaction completes, periodically, or at some other event. Flagging a transaction eventually results in the particular instance of the transaction being reported to enterprise manager 120 by agent 8. Not every invocation is reported in one embodiment. Upon the detection of a reporting event, flagged transaction instances are detected, data is accessed for the flagged transactions, and the accessed data is reported. This is discussed in more detail below with respect to the method of FIG. 14.

FIG. 14 illustrates a flow chart of an embodiment of a method for reporting anomaly events. A reporting event is detected at step 810. The reporting event may be the occurrence of the expiration of a timer, a request received from enterprise manager 120, or some other event. A first transaction trace data set is accessed at step 820. In one embodiment, one set of data exists for each transaction performed since the last reporting event. Each of these data sets are analyzed to determine if they are flagged for reporting to enterprise manager 120.

After accessing the first transaction trace data set, a determination is made as to whether the accessed data set is flagged to be reported at step 830. A transaction may be flagged at step 715 or 725 in the method of FIG. 13 if it is determined to be an anomaly. If the current accessed transaction is flagged to be reported, component data for the transaction is built at step 850. Building component data for a transaction may include assembling performance, structural, relationship and other data for each component in the flagged transaction as well as other data related to the transaction as a whole. The other data may include, for example, a user ID, session ID, URL, and other information for the transaction. After building the component data for the transaction, the component and other data is added to a report package at 860. The report package will eventually be transmitted to enterprise manager 120 or some other module which handles reporting or storing data. After adding the transaction data to the report package, the method at FIG. 10 continues to step 870. If the currently accessed transaction data is not flagged to be reported, the transaction data is ignored at step 840 and the method continues to step 870. Ignored transaction data can be overwritten, flushed, or otherwise ignored. Typically, ignored transaction data is not reported to an enterprise manager 120. This reduces the quantity of data reported to an enterprise manager from the server and reduces the load on server resources.

A determination is made as to whether more transaction data sets exists to be analyzed at step 870. If more transaction data sets are to be analyzed to determine if a corresponding transaction is flagged, the next transaction data set is accessed at step 880 and the method returns to step 830. If no further transaction data sets exist to be analyzed, the report package containing the flagged data sets and component data is transmitted to enterprise manager 120 at step 890.

The foregoing detailed description has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A computer-implemented method of determining a normal range of behavior for an application, comprising:
accessing performance data associated with a metric for a plurality of transactions of an application;
accessing an initial range multiple for the metric;
calculating a variability measure for the metric based on a maximum value, minimum value and arithmetic mean of the performance data;
modifying the initial range multiple based on the calculated variability measure for the metric; and
automatically establishing a baseline for the metric based on the modified range multiple.

2. The method of claim 1, further comprising:
automatically instrumenting object code of the application to monitor the plurality of transactions.

3. The method of claim 1, wherein accessing an initial range multiple for the metric comprises establishing the initial range multiple based on a default value.

4. The method of claim 1, further comprising:
determining a standard deviation of the performance data for the metric;
determining an average value of the performance data for the metric;
determining a product of the standard deviation and the modified range multiple;
determining a sum of the average value and the product;
determining a difference of the average value and the product; and
wherein the baseline for the metric includes a comparison threshold for the metric based on the sum and the difference.

5. A method according to claim 4, wherein automatically establishing the baseline for the metric, includes:
establishing a first comparison threshold for the metric when the variability of the metric is at a first value; and
establishing a larger comparison threshold when the variability of the metric is at a second value that is less than the first value.

6. A method according to claim 1, further comprising:
receiving a user-defined desired sensitivity for the metric; and
wherein establishing the baseline for the metric is based on the modified range multiple and the user-defined sensitivity for the metric.

7. A method according to claim 6, further comprising:
determining a sensitivity multiple based on the user-defined sensitivity, a maximum sensitivity and a default sensitivity;
wherein establishing the baseline metric includes adjusting the modified range multiple using the sensitivity multiple.

8. A method according to claim 1, further comprising:
monitoring the application to determine additional performance data for the metric after establishing the baseline for the metric;
comparing the additional performance data for the metric to the baseline for the metric;
determining if the metric for the application is anomalous based on the comparing; and
reporting, responsive to the determining.

9. A method according to claim 8, further comprising:
updating the established baseline for the metric using the additional performance data.

10. A method according to claim 1, wherein:
the range multiple is a number of standard deviations for the metric.

11. An apparatus, comprising:
a communication interface;
a storage device; and
one or more processors in communication with the storage device and the communication interface, the one or more processors adapted to access performance data associated with a metric for a plurality of transactions of an application, access an initial range multiple for the metric, calculate a variability measure for the metric based on a maximum value, minimum value and arithmetic mean of the performance data, modify the initial range multiple based on the calculated variability measure for the metric, and automatically establish a baseline for the metric based on the modified range multiple.

12. An apparatus according to claim 11, further comprising:
one or more agents, said one or more agents collect data about the plurality of transactions; and
an enterprise manager implemented by the one or more processors to communicate with the one or more agents and establish the baseline for the metric.

13. An apparatus according to claim 11, wherein the one or more processors are adapted to:
determine a standard deviation of the performance data for the metric;
determine an average value of the performance data for the metric;
determine a product of the standard deviation and the modified range multiple;
determine a sum of the average value and the product;
determine a difference of the average value and the product; and
wherein the baseline for the metric includes a comparison threshold for the metric based on the sum and the difference.

14. An apparatus according to claim 11, wherein the one or more processors are adapted to:
receive a user-defined desired sensitivity parameter for the metric; and
establish the baseline for the metric based on the modified range multiple and the user-defined sensitivity for the metric.

15. An apparatus according to claim 14, wherein the one or more processors are adapted to:
determine a sensitivity multiple based on the user-defined sensitivity, a maximum sensitivity and a default sensitivity; and
establish the baseline metric by adjusting the modified range multiple using the sensitivity multiple.

16. An apparatus according to claim 11, wherein the one or more processors are adapted to:
monitor the application to determine additional performance data for the metric after establishing the baseline for the metric;
compare the additional performance data for the metric to the baseline for the metric;
determine if the metric for the application is anomalous based on the comparing; and
report, responsive to the determining.

17. One or more processor readable storage devices having process readable code embodied thereon, said processor readable code for programming one or more processors to perform a method comprising:
monitoring a plurality of transactions associated with an application;
generating performance data for the plurality of transactions of the application, the performance data corresponding to a selected metric;
establishing a default deviation threshold for the selected metric;
modifying the default deviation threshold using a calculated variability measure for the selected metric based on the performance data;
automatically establishing a baseline for the selected metric using the modified deviation threshold;
comparing the generated performance data for the plurality of transactions to the baseline for the metric; and
reporting one or more transactions having performance data outside of the baseline for the selected metric.

18. One or more processor readable storage devices according to claim 17, wherein reporting the one or more transactions includes displaying a user interface with one or more indications that the one or more transactions contain an anomaly.

19. One or more processor readable storage devices according to claim 17, wherein the method further comprises:
calculating a sensitivity multiple based on a user-defined sensitivity parameter;
wherein automatically establishing a baseline for the selected metric includes combining the sensitivity multiple with the modified deviation threshold and determining at least one comparison threshold based on the combination of the sensitivity multiple and the modified deviation.

20. One or more processor readable storage devices according to claim 17, wherein the method further comprises:
dynamically updating the baseline for the selected metric in response to additional performance data generated for one or more additional transactions of the application.

21. One or more processor readable storage devices according to claim 17, wherein generating performance data for the plurality of transactions of the application includes reporting transaction events to an agent by monitoring code added to object code for the application.

22. A computer-implemented method of application performance management, comprising:
accessing performance data associated with a metric of an application;
establishing an initial baseline for the metric;
modifying the initial baseline based on a calculated variability of the performance data associated with the metric;
determining at least one comparison threshold for the metric using the modified baseline for the metric;
generating additional performance data associated with the metric of the application;
comparing the additional performance data with the at least one comparison threshold; and
reporting one or more anomalies associated with the application responsive to the comparing.

23. The method of claim 22, wherein comparing the additional performance data with the at least one comparison threshold includes:
identifying a range of performance data values for the application; and
determining if the additional performance data is contained within the identified range.
